(19) United States
(12) Patent Application Publication
(10) Pub. No.: US 2011/0112936 A1
(43) Pub. Date: May 12, 2011

(54) SYSTEMS AND METHODS FOR ORDERING AND DELIVERY OF GOODS

(76) Inventor: DWIGHT HENDRICKSON, McDonough, GA (US)

(21) Appl. No.: 12/944,574

(22) Filed: Nov. 11, 2010

Related U.S. Application Data
(60) Provisional application No. 61/260,521, filed on Nov. 12, 2009.

(51) Int. Cl. G06Q 30/00; G06Q 90/00; B65G 51/00

(52) U.S. Cl. 705/27.1; 705/500; 406/184

(57) ABSTRACT

A system for the ordering and delivery of goods may comprise an ordering system for accepting a selection of the goods for purchase and a pneumatic mechanism for delivering the goods from a first location to a second location. The system may be located in gas stations so that a customer pumping fuel at a fuel delivery pump may be able to purchase and receive goods while at the fuel delivery pump without going inside the store of the gas station.

### CROSS-REFERENCE TO RELATED APPLICATIONS

This application claims the benefit of priority to U.S. provisional patent application No. 61/260,521 filed Nov. 12, 2009, and incorporated herein by reference.

### BACKGROUND OF THE INVENTION

The present invention generally relates to ordering and delivery of goods, and more particularly relates to systems and methods for accepting orders from a customer at a fuel dispenser and delivering the ordered goods from the inside of a store to the customer at the fuel dispenser via a pneumatic mechanism.

### SUMMARY OF THE INVENTION

In one aspect of the present invention, a system for ordering and delivery of goods comprises an ordering system for accepting a selection of the goods for purchase; and a pneumatic mechanism for delivering the goods from a first location to a second location.

In another aspect of the present invention, a method for ordering and delivery of goods comprises accepting, by an ordering system at a remote location, a selection of the goods for purchase; accepting, by the ordering system payment information for the goods; and delivering the goods via a pneumatic mechanism from an inside location within a store to the remote location.

These and other features, aspects and advantages of the present invention will become better understood with reference to the following drawings, description and claims.

### BRIEF DESCRIPTION OF THE DRAWINGS

FIG. 1 shows a schematic view of a system for ordering and delivery of goods in a typical installation in accordance with an embodiment of the present invention;

FIG. 2 shows a front view of a display screen of the system of FIG. 1 in a first configuration;

FIG. 3 shows a front view of the display screen of FIG. 2 in a second configuration; and

FIG. 4 shows a flowchart of a method for ordering and delivery of goods in accordance with an embodiment of the present invention; and

FIG. 5 shows a continuation of the flowchart of FIG. 4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide systems and methods for the ordering and delivery of goods.

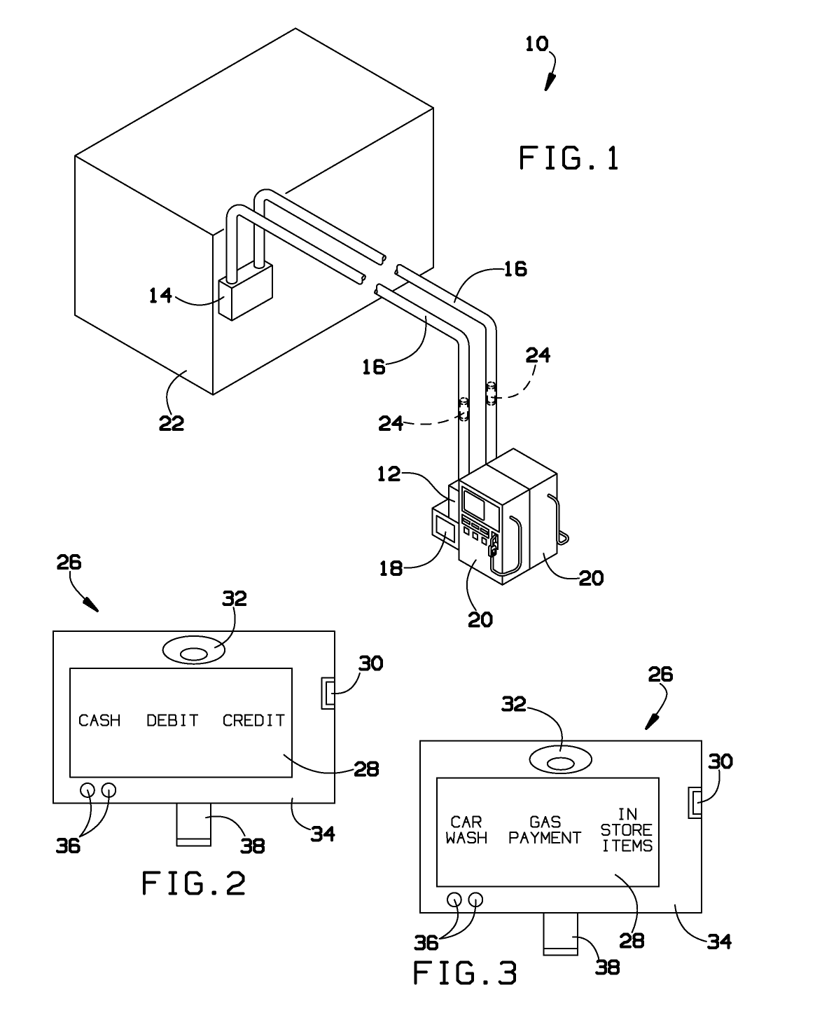

Referring now to FIG. 1, a system 10 for the ordering and delivery of goods may be implemented in a gas station environment, where a customer fueling his car at a fuel delivery pump 20 may be able to order, pay for, and receive goods while situated at the fuel delivery pump 20 without having to enter a store 22, such as a convenience store, at the gas station.

Goods located within the store 22 that are ordered by the customer situated at the fuel delivery pump 20 may be delivered via a pneumatic mechanism that connects the store 22 with the fuel delivery pump 20. The pneumatic mechanism may include pneumatic transfer tubes 16 that connect a master station 14 at the store 22 to a substation 12 at the fuel pump 20. The master station 14 may be able to control the sending and receiving of carriers 24 through the transfer tubes 16, while the substation 12 may be able to receive the carriers 24.

A receive-item bin 18 at the fuel pump 20 may allow access to a carrier 24, so that the customer may be able to place cash into the carrier 24 for sending to the store 22 via the pneumatic transfer tube 16, or so that the customer may be able to retrieve the ordered goods from the carrier 24.

Referring now to FIGS. 2 and 3, an ordering system 26 may be located at each fuel pump 20 to be used by the customer to order and pay for goods and services. The ordering system 26 may be a computer, such as a general purpose computer, or may be specialized computerized hardware, and maybe networked, such as to a computer terminal inside the store 22, to communicate information, such as payment information and the goods purchased by the customer, to the computer terminal inside the store.

The ordering system 26 may be mounted on each fuel pump 20 via a monitor stand 38, and the ordering system 26 may include a motion detector so that the ordering system 26 may be turned on only when it senses the motion of a vehicle in front of it, thereby saving energy. The ordering system 26 may also include volume controls 36 to control the volume of any sounds from the ordering system 26.

The ordering system 26 may include a monitor 34 having a touchscreen display 28 for accepting input from the customer and for displaying output to the customer. As shown in FIG. 2, the ordering system 26 may allow the customer to pay for ordered goods, such as via cash, credit card, or debit card. The ordering system 26 may also include a card reader 30 for reading the credit card or debit card of the customer. As shown in FIG. 3, the ordering system may allow the customer to order goods and services, including gas, a car wash, or any goods located inside the store 22.

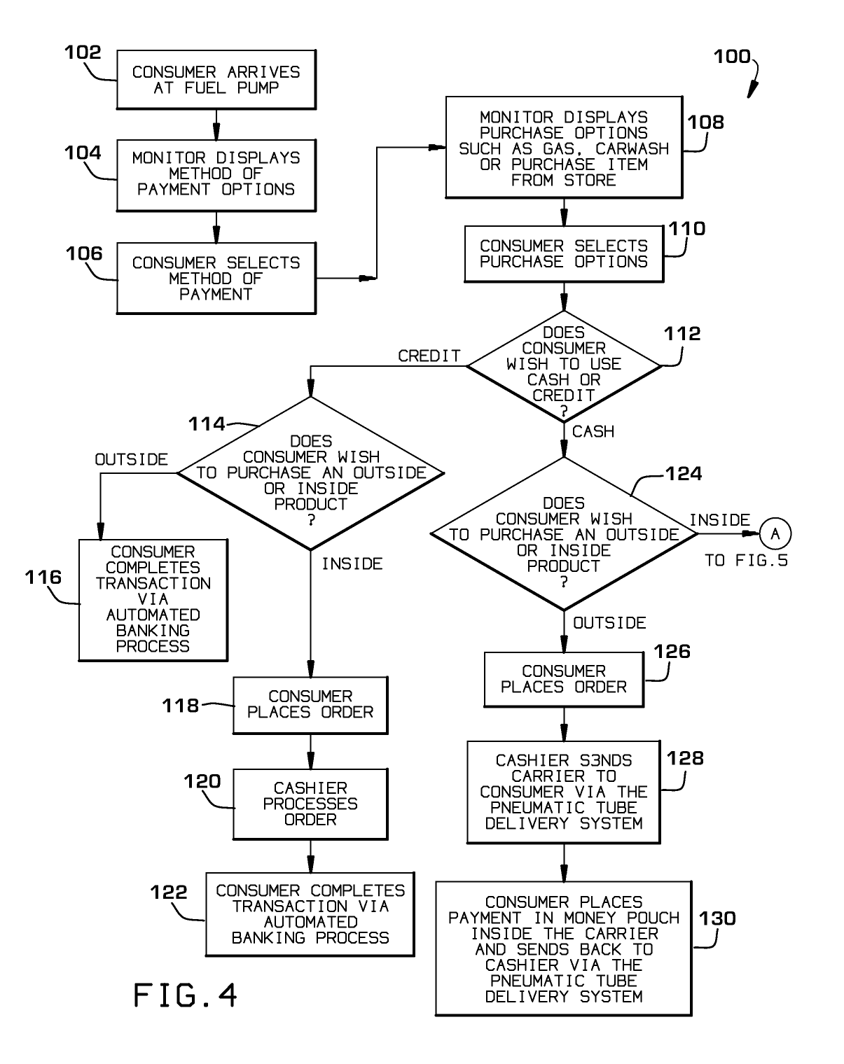

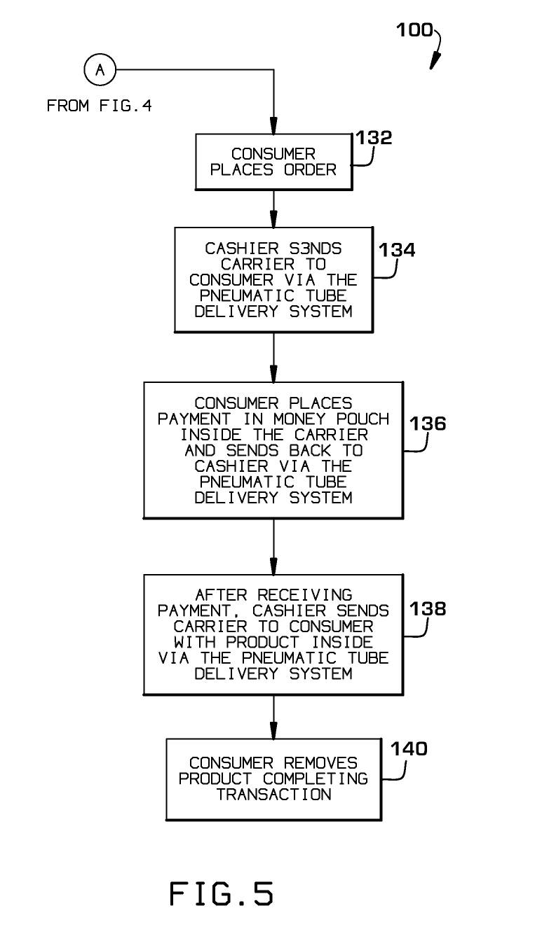

Referring now to FIGS. 4 and 5, which show a flowchart of a method 100 for the ordering and delivery of goods, at 102, when a customer arrives at a fuel pump 20, at 104 the motion detector 32 on the ordering system 26 at the fuel pump 20 may cause the monitor 28 to turn on and to display payment method options. At 106, the monitor 28 may accept a selection of the payment method. At 108, the monitor 28 may display purchase options, such as gas, car washes, or good within the store 22 that are available for purchase. The monitor 28 may also display information such as pictures and prices of the items. At 110, the monitor 28 may accept a selection of goods and services that the customer wishes to purchase.

At 112, a determination may be made of whether the customer is paying with cash or credit. If the customer is paying with credit, at 114 a determination may be made of whether the customer wishes to purchase a product that is inside of the store 22. If the purchased product is outside of the store 22, at 116 the monitor 28 may help the customer to complete his transaction via an automated banking process, including having the customer swipe his credit card via the card reader 30 and processing the credit card with the credit card institution. On the other hand, if the purchased product is inside the store 22, at 118, the monitor 28 may accept an order placed by the customer. At 120, the ordering system 26 may send information regarding the order to a computer within the store 22. An employee within the store 22 may process the order by gathering the purchased items, placing the purchased items in a carrier 24, and sending the carrier 24 containing the purchased items via the transfer tubes 16 to the fuel delivery pump 20 where the customer is situated. The customer may then retrieve the carrier 24 from the receive-item bin 18 at the fuel delivery pump 20. At 122, the monitor 28 may help the customer to complete his transaction via an automated banking process, including having the customer swipe his credit card via the card reader 30 and processing the credit card with the credit card institution.

On the other hand, if the customer is paying with cash, at 124 a determination may be made of whether the customer wishes to purchase a product that is located inside the store 22. If the customer wishes to purchase a product that is located outside of the store 22, at 126 the monitor 28 may accept the order. At 128, the employee inside the store 22 may send a carrier 24 via the transfer tubes 16 to the fuel delivery pump 20 where the customer is situated. At 130, the customer may place cash inside the carrier 24 and send it back to the employee.

If the customer wishes to pay cash to purchase products that are located inside the store 22, at 132 the monitor 28 may accept the order. At 134, the employee inside the store 22 may send a carrier 24 via the transfer tubes 16 to the fuel delivery pump 20 where the customer is situated. At 136, the customer may place cash inside the carrier 24 and send it back to the employee. At 138, once the employee receives the cash, the employee may process the order by gathering the purchased items, placing the purchased items in a carrier 24, and sending the carrier 24 containing the purchased items via the transfer tubes 16 to the fuel delivery pump 20 where the customer is situated. At 140, the customer may then retrieve the carrier 24 from the receive-item bin 18 at the fuel delivery pump 20 and remove the purchased items from the carrier 24.

Besides gas station environments, the systems and methods described above may be used in any situations where the ordering and delivery of goods and services may occur.

It should be understood, of course, that the foregoing relates to exemplary embodiments of the invention and that modifications may be made without departing from the spirit and scope of the invention as set forth in the following claims.

We claim:

1. A system for ordering and delivery of goods, comprising:
an ordering system for accepting a selection of the goods for purchase; and
a pneumatic mechanism for delivering the goods from a first location to a second location.

2. The system of claim 1, wherein the first location is inside a store and the second location is at a fuel delivery pump.

3. The system of claim 2, wherein the ordering system is at the second location and comprises a touchscreen for accepting the selection of the goods for purchase.

4. The system of claim 3, wherein the ordering system is activated upon sensing movement near the ordering system.

5. The system of claim 1, wherein the pneumatic mechanism comprises pneumatic tubes between the first location and the second location for carrying a carrier between the first location to the second location.

6. A method for ordering and delivery of goods comprising:
accepting, by an ordering system at a remote location, a selection of the goods for purchase;
accepting, by the ordering system, payment information for the goods; and
delivering the goods via a pneumatic mechanism from an inside location within a store to the remote location.

7. The method of claim 6, further comprising:
communicating the selection of the goods for purchase to a computer at the inside location within the store.

8. The method of claim 6, wherein the delivering comprises sending a carrier containing the goods from the inside location to the remote location via the pneumatic mechanism.

9. The method of claim 6, further comprising:
sending cash payment for the goods from the remote location to the inside location via the pneumatic mechanism.

10. The method of claim 6, wherein the pneumatic mechanism comprises a pneumatic tube.
